(19) United States
(12) Patent Application Publication
(10) Pub. No.: US 2024/0112362 A1
(43) Pub. Date: Apr. 4, 2024

(54) Method and system for automatic scanning and focusing of uneven surfaces for identification and classification of particulates

(71) Applicants: Prithviraj Pralhad Jadhav; Sandeep Arvind Kulkarni

(72) Inventors: Prithviraj Pralhad Jadhav; Sandeep Arvind Kulkarni

(21) Appl. No.: 17/958,462

(22) Filed: Oct. 3, 2022

(51) Int. Cl. G06T 7/70; G06T 5/00; G06T 7/40; G06T 7/62; G06V 10/44; G06V 10/764

(52) U.S. Cl. CPC G06T 7/70; G06T 5/002; G06T 7/40; G06T 7/62; G06V 10/44; G06V 10/764; G06T 2207/10024; G06T 2207/10056; G06T 2207/20104; G06T 2207/20132

(57) ABSTRACT

Disclosed herein is a method, and its implementing system, whereby detection, classification and identification of objects of interest (namely, particulates) can be conveniently and rapidly undertaken, if any present and seen, in one or more photographic images of a sample being analyzed.

### CROSS REFERENCES TO RELATED APPLICATIONS

This non-provisional patent application claims the benefit of U.S. provisional application No. 63/251,640 filed on 3 Oct. 2021, the contents of which are incorporated herein in their entirety by reference.

### STATEMENT REGARDING FEDERALLY SPONSORED RESEARCH OR DEVELOPMENT

None applicable

### REFERENCE TO SEQUENCE LISTING, A TABLE, OR A COMPUTER PROGRAM LISTING COMPACT DISC APPENDIX

None

### FIELD OF THE INVENTION

This invention relates generally to the field of image processing and particularly to applications thereof for qualitative and quantitative analyses. An isolated embodiment of the present invention is disclosed in this paper, which relates specifically to a method, and its implementing system, whereby detection, classification and identification of objects of interest (namely, particulates) can be conveniently and rapidly undertaken, if any present and seen, in one or more photographic images of a sample being analyzed.

### BACKGROUND OF THE INVENTION AND DESCRIPTION OF RELATED ART

Image processing generally refers to digitization of optical images, and performing operation(s) on the so-converted data to augment and/or extract further meaningful information, preferably in an automated manner. Signal dispensation of source data, approach for processing said input source data and interpretation of post-processing output are major areas of interdisciplinary research in field of the present invention wherein image visualization, restoration, retrieval, measurement and recognition are prime loci of progressive investigation.

Particle analysis and particle characterization are major areas of research in new drug or formulation development in pharmaceutical industry. A proper analysis of particle size and shape reduces development time to a great extent. However, most of the current microscopic analysis is done manually which requires more time besides being prone to subjective interpretation and requires an expert to take the decision.

Processing of microphotographic images, in above parlance, is found to be employed variably in state-of-art technologies for study of microscopic particles wherein identifying indicia among their physical, chemical, compositional, morphological attributes and/or physiological behaviors are utilized for qualitative and/or quantitative determinations including identification and size distribution of the particles under study. However, such implements are presently limited to non-visual light microscopy applications such as X-ray microtomography (μCT), transmission electron microscopy (TEM), scanning electron microscopy (SEM) and the like. Therefore, it would be advantageous to have some means for availing advantages of image processing technology for visual light/optical microscopy, particularly particle analysis applications.

Conventionally, detection and classification of particles has been practiced via sieving, sedimentation, dynamic light scattering, electrozone sensing, optical particle counting, XRD line profile analysis, adsorption techniques and mercury intrusion or further indirect methods such as surface area measurements. However, resolution of these techniques leave a lot to be desired, besides relying on availability of expensive equipment and collateral prior expertise of skilled operators for arriving at the determination intended. Such analysis, as will be obvious to the reader, tends to be less reproducible due to unavoidable personal biases and therefore inaccurate for faultless determinations. There is hence a need for some way that makes possible the integration of image analytics for particle classification in optical microscopy applications.

The art therefore requires a particle identification and classification technology that is capable of plug-and-play integration in existing optical microscopy application environments with minimal bias on capital, integration and operative expenses and at the same time, being of a nature that allows accurate and precise implementation by any person even ordinarily skilled in the art. Ability to succinctly discern despite strong variability among objects of interest, low contrast, and/or high incidence of agglomerates and background noise are additional characters desirable in said particle identification and classification technology presently lacking in state-of-art.

A better understanding of the objects, advantages, features, properties and relationships of the present invention will be obtained from the underlying specification, which sets forth the best mode contemplated by the inventor of carrying out the present invention.

### OBJECTIVES OF THE PRESENT INVENTION

The present invention is identified in addressing at least all major deficiencies of art discussed in the foregoing section by effectively addressing the objectives stated under, of which:

It is a primary objective to provide an effective method for automatic scanning and focusing of uneven surfaces for identification and classification of particulates.

It is another objective further to the aforesaid objective(s) that the method so provided is fully automated via fast and optimized computational logic with low processing time, low demands on processor resources, and effective use of available computer memory stores.

It is another objective further to the aforesaid objective(s) that the method so provided is error-free and lends itself to accurate implementation even at hands of a user of average skill in the art.

It is another objective further to the aforesaid objective(s) that implementation of the method so provided does not involve any complicated or overtly expensive hardware.

It is another objective further to the aforesaid objective(s) that implementation of the method is possible via a remote server, in a software-as-a-service (SaaS) model.

The manner in which the above objectives are achieved, together with other objects and advantages which will become subsequently apparent, reside in the detailed description set forth below in reference to the accompanying drawings and furthermore specifically outlined in the independent claims. Other advantageous embodiments of the invention are specified in the dependent claims.

### BRIEF DESCRIPTION OF DRAWINGS

The present invention is explained herein under with reference to the following drawings, in which,

FIG. 1 is a flowchart describing general logic for implementation of the present invention substantially according to the disclosures hereof.

FIG. 2 is a flowchart describing logic for the AutoScanner feature included in the logic presented at FIG. 1.

The above drawings are illustrative of particular examples of the present invention but are not intended to limit the scope thereof. Though numbering has been introduced to demarcate reference to specific components in relation to such references being made in different sections of this specification, all components are not shown or numbered in each drawing to avoid obscuring the invention proposed.

Attention of the reader is now requested to the detailed description to follow which narrates a preferred embodiment of the present invention and such other ways in which principles of the invention may be employed without parting from the essence of the invention claimed herein.

### SUMMARY OF THE PRESENT INVENTION

The present invention propounds a fast and resource-optimized computer-implemented automated methodology for automatic scanning and focusing of uneven surfaces for identification and classification of particulates using a microscope having a motorized stage which is fitted with an imaging system such as a camera.

### DETAILED DESCRIPTION

Principally, general purpose of the present invention is to assess disabilities and shortcomings inherent to known systems comprising state of the art and develop new systems incorporating all available advantages of known art and none of its disadvantages. Accordingly, the disclosures herein are directed towards establishment of a method, and its implementing system, whereby detection, classification and identification of objects of interest (namely, particulates) can be conveniently and rapidly undertaken, if any present and seen, in one or more photographic images of a sample being analyzed.

In the embodiment recited herein, the reader shall presume that images referred are ones obtained from a microscope having a motorized stage which is fitted with an imaging system such as a camera. For this, a sample to be analyzed is processed using standard microscopy sample preparation and taken on stage of microscope for microphotography. As will be realised further, resolution of the present invention is correlated with optics of the microscope, and not the camera or computing system involved. Camera fitments for optical microscopes are inexpensive and commonly available. Assemblage and operations of these components requires no particular skill or collateral knowledge. Hence, the present invention is free of constraints entailing otherwise from capital, operation and maintenance costs besides negating the requirement of trained skilled operators for implementation of the present invention.

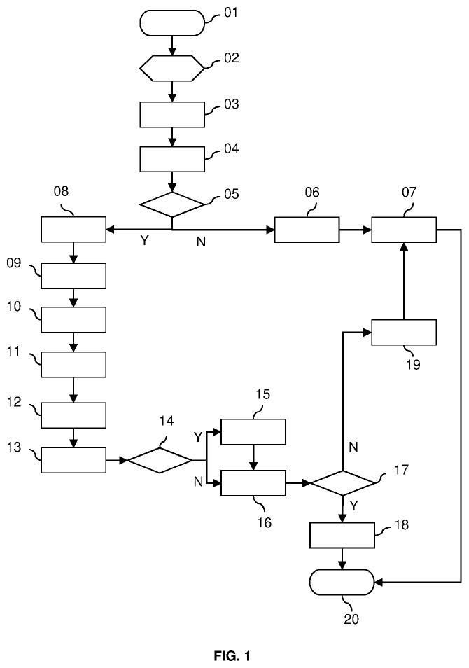

Reference is now made to the accompanying FIG. 1, which is a flowchart describing general logic for implementation of the present invention. As seen here, execution of the present invention begins at step (01) where the user initializes/starts the application of the present invention (named “ipvPAuto” and referred so throughout this document). This triggers step (02) in which the user is prompted (via suitable user interface) to create/select method to set particle range, magnification selection etc. Once this is done, step (03) is caused to be executed, wherein the analysis area is scanned (by a routine named “AutoScanner”), and images captured are saved with names/identification of the scan position.

With continued reference to the accompanying FIG. 1, it can be seen that once image data is available as per foregoing narration, a Scanning info text file is created via step (04) by AutoScanner specifying therein number of rows, number of columns, and total fields. Thereafter, a it is determined via query at step (05), as to whether the image is captured by AutoScanner and ready in a shared folder. If determination is negative, the execution is paused at step (06) till this is achieved, else, the logic is programmed to terminate (after suitable threshold/benchmark) via step (07). If determination is positive, execution logic is directed, via step (08) to read the image and image position (row and column in scan area from name).

With continued reference to the accompanying FIG. 1, it can be seen that once image is read, the image data is preprocessed via step (09) to smoothen said image by removing noise. Thereafter, contours in said image are identified, via step (10) and contours of same gray value variation (gradient) are mapped out. This allows, in step (11) for identification of objects via a sub-process including forming contour groups, and finding best contour from group from user criteria selection (Sharpness, Bounding box, Circularity, and Perimeter).

With continued reference to the accompanying FIG. 1, it can be seen that once objects are identified, feature computation is undertaken via step (12) on basis of size, shape, color, and texture. Thereafter, pre-arranged/pre-programmed filters are applied at step (13) to remove artifacts. Filters applied are selected among group including a) size filter—Filter Particles not in defined range; b) Sharpness Filter—Filter blur particles (less than defined sharpness); and c) Agglomeration Filter—Filter non isolated particles identified on shape features.

With continued reference to the accompanying FIG. 1, it can be seen that after the determinations described above, the logic hereof is programmed to determine, at step (14), as to whether the identified object/particle on left or top of the image boundary. If this determination is positive, sub-process is triggered at step (15), whereby boundary particle identification is achieved by steps of a) searching overlapping particle in left/top image; b) Cropping image parts to create new cropped image; and c) Finding particle in the cropped image. If this determination is negative, another sub-process is triggered at step (16), whereby particle classification is achieved via steps of a) Adding particles in particle list; b) sorting particles in defined particle range; and c) Adding image in scanned area list.

With continued reference to the accompanying FIG. 1, the reader shall appreciate another determination being posed at step (17), whereby it is sought to be determined whether or not it is the last image of total fields. If this determination is positive, computation of result statistics is triggered at step (18). Else, if this determination is negative, the logic is programmed to lead via step (19) to terminate (after suitable threshold/benchmark) via step (07). Else, the logic is deemed to execute in intended manner, and culminates via step (20).

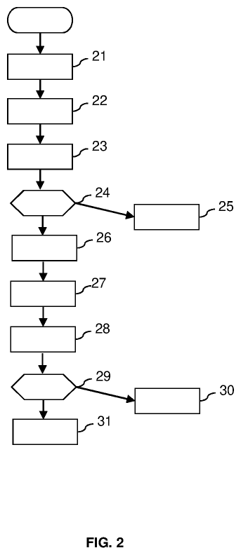

According to a related aspect of the present invention explained with reference to the accompanying FIG. 2, execution of the AutoScanner feature introduced above can be seen in that it initiates, via step (21) in which a scanning map is created. For this, scanning map from input magnification is created, and then scanning information (for example, rows, cols, fields) is saved in file in shared folder with ipvPAuto at step (22). Thereafter, microscope stage is automatically moved in step (23) to the center position of the scanning area. Once this is arrived at, the AutoScanner is initialized at step (24) by a sub-process comprising a) Moving the stage automatically to find optimum focus position; b) Computing brightness, sharpness and focusing range; and c) Computing texture value.

With continued reference to the accompanying FIG. 2, it shall be seen that once texture value is computed, it is subjected to a determination via step (25) to assess whether the texture value measures is high (than a known texture value of the filter paper used). If this determination is positive, a message is outputted to the user at step (26), that filter paper (sample is presumed to be held on this filter paper) is absent and scanning should be stopped. If determination here is positive however, stage is automatically moved, at step (27) to the start of the scanning. Thereafter, scanning is performed at step (28) by a) Moving stage in x direction by one step; b) When end field reached of the row, moving one step down; c) Moving stage in opposite x direction; d) When end field reached of the row, moving one step down; e) Continuing scan until end of field is reached.

With continued reference to the accompanying FIG. 2, auto-focusing for other than boundary fields is undertaken at step (29), by sub-process including a) Auto focusing on computing the focus direction; b) Capturing and saving image in shared folder; c) If totally de-focused, outputting a message for focusing and wait to restart scanning. Thereafter, the logic is programmed to seek at step (30), whether or not the current field is imaged the last field. If yes, scanning is instructed to stop via step (31), else, the system loops to scanning as per step (28) described above.

Via implementation logic disclosed, it shall be appreciated how detection, classification and identification of objects of interest (namely, particulates) is brought about by the present invention. As will be generally realized, applicability and/or performance of the present invention is not designed to be dependent on any particular sample composition and/or preparation techniques. Accordingly, the present invention is able to process microphotographic images of samples including dry powder, liquid, gel, jelly, aerosols, emulsions, suspension, dispersion and so on and in practice, has been observed to provide results in few seconds.

As will be realized further, the present invention is capable of various other embodiments and that its several components and related details are capable of various alterations, all without departing from the basic concept of the present invention. Accordingly, the foregoing description will be regarded as illustrative in nature and not as restrictive in any form whatsoever. Modifications and variations of the system and apparatus described herein will be obvious to those skilled in the art. Such modifications and variations are intended to come within ambit of the present invention, which is limited only by the appended claims.

We claim:

1) A method for automatic scanning and focusing of uneven surfaces for identification and classification of particulates, the method comprising—
a) Constituting an application environment by communicatively associating an optical microscope having a motorized stage to a computer, wherein—
the method for automatic scanning and focusing of uneven surfaces for identification and classification of particulates is provisioned for execution, as an executable software, on said computer; and
the optical microscope is outfitted with a digital camera for capturing images from the field of view of said microscope and relaying said captured images in real time to said computer for processing by the executable software provisioned on said computer.
b) Defining, via a computer user interface of the executable software, a set of scanning parameters being opted at instance of the user among particle size, analysis area, scan position, and magnification;
c) In accordance with the defined set of scanning parameters, causing at least one image to be captured from the microscope corresponding to the analysis area selected, therein saving the at least one image to a ready shared folder in memory of the computer with its filename corresponding to the scan position selected;
d) In accordance with logic of the executable software—
creating a text file specifying therein the number of rows, number of columns, and total fields;
Via an interactive user interface, allowing the user to set a set of predefined parameters for object determination, said parameters being sharpness, bounding box, circularity, and perimeter;
If saved to the ready shared folder, reading the at least one image and its filename, and preprocessing it by smoothening said at least one image for removal of noise;
Identifying contours in said at least one image, therein selecting contours of same gray value variation to form contour groups and determining, among said contour groups, the best contours on basis of the predefined parameters for object determination;
Once objects are identified, computing feature data corresponding to said objects on basis of their size, shape, color, and texture;
Applying at least one filter on basis of size, sharpness, and agglomeration to the feature data generated to remove artifacts and result in filtered object data;
Determining whether the filtered object data corresponds to objects present on the left and top boundaries of the image under processing, and based on this determination, causing the execution of a suitable sub-process for resulting in either between boundary particle identification and particle classification respectively;
Determining whether the image being processed is the last image of total fields, and based on this determination, causing the execution of a suitable sub-process for either between termination with computation of result statistics and termination of the execution of the executable software upon reaching threshold of the user-defined parameter values respectively.
e) In accordance with flow of execution at step d), causing execution of the AutoScanner sub-process included in the executable software, said sub-process consisting of—
Creating a scanning map from input magnification to generate scanning information consisting of the rows, columns and fields is saved in the ready shared folder;
Causing the microscope stage to move automatically, to the center position of the scanning area;
Once center position of the scanning area is arrived at, moving the microscope stage to find an optimum focus position and therein computing the brightness, sharpness, focusing range and texture value;
Determining whether the computed texture value measures is higher than the known texture value of the filter paper used to hold the sample and based on this determination, causing the execution of a suitable sub-process for resulting in stoppage or commencement of scanning respectively.
f) Auto-focusing for other than boundary fields, therein determining whether the current field imaged is the last field and based on this determination, causing the execution of a suitable sub-process for resulting in stoppage or continued scanning by looping the aforesaid steps respectively.

2) The method for automatic scanning and focusing of uneven surfaces for identification and classification of particulates according to claim 1, wherein, if the filtered object data corresponds to objects present on the left and top boundaries of the image under processing, the suitable sub-process caused to be executed is for boundary particle identification, said sub-process consisting of—
a) Searching overlapping particle in the left and top image;
b) Cropping image parts to create new cropped image; and
c) Finding boundary particle in the cropped image.

3) The method for automatic scanning and focusing of uneven surfaces for identification and classification of particulates according to claim 1, wherein, the filtered object data does not corresponds to objects present on the left and top boundaries of the image under processing, the suitable sub-process caused to be executed is for particle classification, said sub-process consisting of—
a) Adding particles in particle list;
b) Sorting particles in the user-defined particle range; and
c) Adding image in scanned area list.

4) The method for automatic scanning and focusing of uneven surfaces for identification and classification of particulates according to claim 1, wherein, if the image being processed is the last image of total fields, the suitable sub-process caused to be executed is for computation of result statistics.

5) The method for automatic scanning and focusing of uneven surfaces for identification and classification of particulates according to claim 1, wherein, if the image being processed is not the last image of total fields, the suitable sub-process caused to be executed is of termination of execution of the executable software.

6) The method for automatic scanning and focusing of uneven surfaces for identification and classification of particulates according to claim 1, wherein, if the computed texture value is higher than the prior known texture value, the suitable sub-process caused to be executed is of outputting a message to the user, via user interface of the executable software, that the filter paper presumed to hold the sample being processed is absent and scanning should be stopped.

7) The method for automatic scanning and focusing of uneven surfaces for identification and classification of particulates according to claim 1, wherein, if the computed texture value is not higher than the prior known texture value, the suitable sub-process caused to be executed is of scanning using with conventional means of automation of the stage of the microscope, said sub-process comprising—
a) Moving stage in one direction by one step;
b) When end field reached of the row in said direction, moving the stage one step down;
c) Moving stage in a direction opposite to that opted for in step a);
d) When end field reached of the row, moving one step down; and
e) Looping steps a) to d) until end of field is reached.

8) The method for automatic scanning and focusing of uneven surfaces for identification and classification of particulates according to claim 1, wherein auto-focusing for other than boundary fields is undertaken by a sub-process comprising—
a) Auto focusing on computing the focus direction;
b) Capturing and saving image in shared folder; and
c) If totally de-focused, outputting a message for focusing and wait to restart scanning.

9) The method for automatic scanning and focusing of uneven surfaces for identification and classification of particulates according to claim 1, wherein if the current field imaged is the last field, the sub-process caused to be executed is of cessation of execution of the executable software.

10) The method for automatic scanning and focusing of uneven surfaces for identification and classification of particulates according to claim 1, wherein if the current field imaged is not the last field, the sub-process caused to be executed is of continuing execution of the executable software until the last field is reached.

11) The method for automatic scanning and focusing of uneven surfaces for identification and classification of particulates according to claim 1, wherein the executable software is provisioned for execution on the computer by either between a standalone installation and online access from a cloud server in a software-as-a-service model.
